(19) United States
(12) Patent Application Publication
(10) Pub. No.: US 2014/0318688 A1
(43) Pub. Date: Oct. 30, 2014

(54) METHODS AND APPARATUS FOR HOT RECAPPING OF A RETREADED TIRE

(71) Applicants: E. Bruce Colby, Greenville, SC (US); Dimitri G. Tsihlas, Greer, SC (US); Cesar E. Zarak, Simpsonville, SC (US)

(72) Inventors: E. Bruce Colby, Greenville, SC (US); Dimitri G. Tsihlas, Greer, SC (US); Cesar E. Zarak, Simpsonville, SC (US)

(73) Assignees: MICHELIN RECHERCHE ET TECHNIQUE S.A., Granges-Paccot (CH); COMPAGNIE GENERALE DES ETABLISSEMENTS MICHELIN, Clermond-Ferrand (FR)

(21) Appl. No.: 14/361,578

(22) PCT Filed: Nov. 30, 2011
(86) PCT No.: PCT/US11/62624

§ 371 Date: May 29, 2014

(51) Int. Cl. B29D 30/54

(52) U.S. Cl. CPC B29D 30/54
USPC 156/96

(57) ABSTRACT

Particular embodiments of the present invention comprise methods for retreading a tire and a retreaded tire formed by such methods. Such methods include assembling a retreaded tire by: applying a bonding layer along an outer side of a pre-existing tread layer of a tire carcass and within the one or more voids arranged within the pre-existing tread layer and applying a new, uncured tread layer along an outer side of the bonding layer. Such methods further include arranging an annular mold about the outer side of the tread of the assembled retreaded tire such that one or more void molding elements are arranged to terminate overtop and adjacent one of the one or more voids arranged within the pre-existing tread layer outer side. Such methods further include molding the new tread layer to the tire carcass according to hot retreading operations.

### BACKGROUND OF THE INVENTION

This invention relates generally to retread tires and more specifically, to methods and apparatus for hot molding retreaded tires.

### DESCRIPTION OF THE RELATED ART

When tires become worn, they can be restored with new tread. Large truck tires and bus tires, for example, are typically retreaded as part of a routine tire-management program. The carcass of these types of tires is often expected to last several hundred thousand miles and be amenable to having a new tread adhered to it several times. Such tires can be quite expensive and are therefore bought with the expectation that their high initial costs are offset by the long service life of the carcass and the low comparative cost of retreading. Indeed, the economics included in the selection and purchase of such tires often dictate that the original tires be capable of being retreaded as many as three or four times or more.

A variety of procedures and different types of equipment are available for use in recapping or retreading pneumatic tires. One of the first steps in retreading a worn tire is to remove remaining tread material from the tire carcass, for example, by a procedure known as buffing. Next a layer of green (uncured) rubber, known as “cushion gum,” may be applied to the carcass. This layer of uncured rubber may be extruded directly onto or applied as a sheet and rolled (stitched) onto the carcass. Next, a tread band is applied atop the layer of cushion gum.

In the cold recapping or retreading process, the tread band is made of cured rubber, and has a tread pattern already impressed in its outer and possibly its inner surface. Such pre-cured bands, as the term is used herein, refer to tread bands that have undergone to some extent a curing process. The tire is then placed in an autoclave, and heated under pressure for an appropriate time to cure the cushion gum layer, and bond the gum layer to the tread and the carcass.

In the hot recapping or retreading process, the tread is made of uncured rubber and typically may have no or very little tread pattern when initially placed on the tire carcass. The tire with the uncured tread is placed in a tire mold and heated under pressure for an appropriate time to cure the gum layer and the tread, to mold the tread with the desired tread pattern, and to cause the gum layer to bond with the tread and the carcass. The term “cure” refers to the formation of cross-links between the elastomer molecules in the rubber compound, otherwise known as vulcanization.

Buffing the old tread off of the tire in preparation of the retreading process removes rubber that is discarded as waste or as a low value by-product. Most or all of this waste rubber that is removed in preparation for retreading is typically replaced during the retreading process as part of the new tread band and cushion gum that is bonded to the carcass during retreading. It would be advantageous if the amount of rubber that is discarded could be reduced, which would consequently reduce the amount of new rubber that is needed.

### SUMMARY OF THE INVENTION

Particular embodiments of the present invention comprise methods for retreading a tire and a retreaded tire formed by such methods. Particular embodiments of such methods include the step of assembling a retreaded tire by providing a tire carcass for retreading, the tire carcass having a pre-existing tread layer extending widthwise across the tire in a lateral direction, the pre-existing layer including one or more voids extending into a thickness of the pre-existing tread layer from an outer side of the pre-existing tread layer. The step of assembling further includes applying a bonding layer along an outer side of the pre-existing tread layer and within the one or more voids arranged within the pre-existing tread layer and applying a new tread layer along an outer side of the bonding layer such that the bonding layer is arranged between the new tread layer and the pre-existing tread layer, the new tread layer being uncured and having a thickness extending between a top side forming an outer, ground-engaging side of the tread layer and a bottom side arranged atop the bonding layer. Particular embodiments of such methods further include the step of arranging an annular mold about the outer side of the tread of the assembled retreaded tire. The mold includes one or more void molding elements each comprising a protruding member extending radially inward from a mold cavity surface configured to engage the outer side of the tread, each of the one or more void molding elements being arranged to terminate overtop and adjacent one of the one or more voids arranged within the pre-existing tread layer outer side. Particular embodiments of such methods further includes molding the new tread layer and concurrently bonding the new tread layer to the tire carcass according to hot retreading operations whereby heat and pressure are applied to the assembled retreaded tire.

The foregoing and other objects, features and advantages of the invention will be apparent from the following more detailed descriptions of particular embodiments of the invention, as illustrated in the accompanying drawings wherein like reference numbers represent like parts of the invention.

### BRIEF DESCRIPTION OF THE DRAWINGS

FIG. 1 is a partial front sectional view of a retreaded tire undergoing a typical hot retreading process within a heated mold, the new tread being arranged atop a buffed pre-existing tread layer of a tire carcass.

FIG. 2 is a partial front sectional view of a worn tire, the tire including a worn pre-existing tread layer that includes a plurality of voids comprising longitudinal grooves, a pair of the grooves comprising pre-existing grooves and one of the grooves comprising a new longitudinal groove, the pre-existing grooves having had been enlarged according to particular embodiments of the invention.

FIG. 3 is a partial from sectional view of the tire of FIG. 2, where a bonding layer has been applied atop the pre-existing tread layer according to an embodiment of the invention, the bonding layer generally filling the depths of the grooves arranged in the pre-existing tread layer.

FIG. 4 is a partial front sectional view of the tire of FIG. 2 whereby a new tread layer comprising a sheet is arranged atop the tire carcass in accordance with an embodiment of the invention.

FIG. 5 is a partial front sectional view of the tire of FIG. 2 whereby a new tread layer comprising a plurality of strips are arranged atop each rib of the pre-existing layer of the tire carcass in accordance with an embodiment of the invention.

FIG. 6 is a partial front sectional view of the tire of FIG. 4 arranged within a heated mold, the mold including a plurality of void molding elements each extending outwardly from an interior surface of a radially outward mold member and into a enlarged void arranged along the pre-existing tread layer according to an embodiment of the invention. Tread material is shown beneath that void molding element within the void, as the tread material may be captured by the void molding element as the void molding element is forces through the tread material arranged above the void within the new tread layer, although, in other embodiments, such tread material may not be present above the void prior to mold closure or such tread may be forced laterally from beneath the void molding element as the mold closes such that only bonding layer material remains beneath the void molding element after mold closure.

FIG. 7 is a partial front sectional view of an alternative embodiment of FIG. 6, whereby the void molding elements have been shortened to extend within voids that have not been enlarged according to an embodiment of the invention.

FIG. 8 is an enlarged view of the terminal end of a void molding element of FIG. 7 according to an alternative embodiment, where the terminal end of the void molding element includes a recess bounded transversely by a pair of extensions, the recess collecting material arranged within the void of the pre-existing tread layer and the extensions forming partitions between the collected material and the surrounding material.

FIG. 9 is a sectional view of the void molding element of FIG. 8 taken along segment 9-9, the void molding element terminal end extending along a non-linear path in an annular, lengthwise direction according to an embodiment of the invention.

### DETAILED DESCRIPTION OF PARTICULAR EMBODIMENTS

Particular embodiments of the present invention comprise retreaded tires and methods of forming retreaded tires under hot recapping operations whereby an uncured new tread is bonded to a used tire carcass. Methods of retreading tires generally include applying a new tread to an existing tire or tire carcass. An existing tire includes a pre-existing tread which is in need of replacement. The pre-existing tread is also referred to herein as a pre-existing tread layer. The need for retreading may arise due to excessive wear or damage to the tread, for example. When a tread is worn, it is often unevenly worn in a lateral direction across the tire or in a longitudinal direction. While the tread may be worn to a depth where certain grooves or other recessed voids no longer exist, in many instances at least many of the recessed voids or grooves remain. Traditionally, any recessed voids remaining in the pre-existing tread are removed during retreading operations in preparation for receiving a new tread.

In the present invention, the pre-existing tire tread (i.e., pre-existing tread layer) is maintained such that as much of the pre-existing tread layer remains as is desired for use in forming the retreaded tire, where the remaining pre-existing layer for use in retreading may include at least a portion of the pre-existing voids in the pre-existing tread layer. This is in lieu of removing the pre-existing tread layer in full or to a reduced thickness whereby all voids, including grooves, no longer remain. In the present invention, by only removing a portion of the pre-existing tread, if any, a reduction in the amount of waste that is generated by the retreading process is accomplished. For example, since tires are typically removed from service for retreading with 4 millimeters (mm) or more of usable tread depth remaining, the usable tread material remaining within the pre-existing tread layer may be preserved in lieu of removing at least a significant amount of the layer according to traditional retreading methods. This not only reduces waste by limiting the amount of material removed and any labor or costs associated with its removal, it may also lead to the reduction in material and costs by enabling the production of thinner treads for completing the retreading process. The grooves remaining in the pre-existing tread layer prior to application of the new tread may or may not be employed according to the methods discussed herein; that is, material cost savings can be realized by employing these methods to preserve any portion of the pre-existing tread layer, even if the grooves are removed, but not all of the material under the grooves.

In particular embodiments, such methods of forming a retread tire include the step of assembling a retreaded tire by providing a tire carcass, the tire carcass having a pre-existing tread layer extending widthwise across the tire in a lateral direction, the pre-existing tread layer including one or more voids extending into a thickness of the pre-existing tread layer from an outer side of the pre-existing tread layer. The pre-existing tread layer has an outer, ground-engaging side from which the tread layer wears. The outer side comprises surface area for engaging the ground and surface void capable of receiving water, snow, mud, etc. during tire operation. The outer side often includes voids extending depthwise into the tread thickness, such as longitudinal or lateral grooves or sipes. Particular embodiments of the step of providing a tire carcass may include forming at least one of the one or more voids arranged along the pre-existing tread layer outer surface prior to the step of applying the bonding layer to the pre-existing tread layer. While the pre-existing tread layer may include one or more voids arranged therein, it is understood that additional voids may be added to the pre-existing tread layer. Therefore, providing a tire carcass having a voids arranged in a pre-existing tread layer may include both voids originally formed in the pre-existing tread layer in its original form and voids formed therein after the pre-existing tread layer has been worn. The added voids may be sized and spaced to accommodate or receive tread void molding elements. In other words, the added voids may have a width at least equal to or wider than a width of the void molding elements used to form a similar void above the added void. For example, if the void molding element is a longitudinal or circumferential groove blade, the added void is wider and deeper than the intended penetration of the void molding element into the pre-existing tread, such that the void molding element touches only uncured rubber. Adding voids may arise, for example, when the mold has more void molding elements than the pre-existing tread layer has voids. Therefore, particular embodiments of forming at least one of the one or more voids arranged along the pre-existing tread outer surface prior to the step of applying the bonding layer to the pre-existing tread layer occurs when the quantity of the one or more voids then existing in the pre-existing tread layer is less than the quantity of the one or more void molding elements extending from the mold and arranged to terminate adjacent one of the or more voids arranged within the pre-existing tread layer outer side in the step of arranging the annular mold about the outer side of the tread, each of the one or more voids being formed at a location configured to facilitate the arrangement achieved in the step of arranging the annular mold about the outer side of the tread.

Such methods may further include the step of removing at least a portion of the pre-existing tread layer to a pre-determined depth from the outer side prior to the step of applying a bonding layer. In preparation for retreading the tire, a portion of the pre-existing tread layer may be removed to any desired depth of the pre-existing tread layer to achieve an outer side of the pre-existing tread layer having any desired shape or profile and to accommodate the installation of any desired new tread. Such removal may be achieved by performing a material removal process with a material removal device. Such device may comprise any means for removing a thickness of the pre-existing tread layer known to one of ordinary skill in the art may be employed. For example, an abrading or cutting operation may be performed using an abrading or cutting tool. An abrading tool may comprise an abrasive rotary disk or drum. A cutting tool may comprise a blade or knife. In particular embodiments, a thickness of material is removed along a full width of the pre-existing tread layer. In other embodiments, tread material is removed at one or more different locations along the width of the pre-existing tread layer. At each location, different amounts or thicknesses of material may be removed as desired. It is also understood that material surrounding recessed voids, such as longitudinal and/or lateral grooves, may be removed in the step of removing. In such instances, the recessed void may be reshaped, widened, and/or deepened as needed to accommodate the application of a bonding layer and/or a new tread. The resulting pre-existing tread layer may be symmetrical or asymmetrical about the tire centerline, and/or may result in a variable thickness tread layer. It is understood that in some embodiments only enough material may be removed from the preexisting tread layer, or a portion thereof, to roughen the surface to facilitate bonding of material thereto, thus preserving essentially all of the pre-existing tread in the layer, or that portion thereof. Using voids arranged within the pre-existing tread layer not only reduce the amount of pre-existing tread layer removed from the tire carcass, it provides additional surface area for additional bonding between the layers. It also provides an interlocking of the layers to further resist any longitudinal or lateral sheering that may be imparted between the tread and tire.

Particular embodiments of such methods may further include the step of enlarging the void arranged within the pre-existing tread of the tire carcass prior to performing the step of applying the bonding layer. Because, in particular embodiments, void molding elements extending outwardly within a mold for forming voids within the tread may arranged relative the tire to terminate adjacent or within a void arranged within the pre-existing layer upon closure of the mold during molding operations, the pre-existing void may need to be enlarged to accommodate the void molding element and/or any tread or bonding layer material arranged therein during the molding operation. For example, enlarging the void, such as a lateral or longitudinal groove or sipe, may be necessary when using an existing, unmodified mold to prevent or reduce the amount of bonding layer and/or new tread layer material under the void molding element extending into the tread and the void to form a corresponding void within the new tread layer, such as a lateral or longitudinal groove or sipe. Enlarging the void includes widening and/or deepening the void within the pre-existing tread layer of the tire carcass. Enlarging may also comprise reshaping the void. It is understood that voids may be arranged within the pre-existing tread to generally match the arrangement of voids in the new tread, while in other instances, the new tread may include a different arrangement of voids to form a new tread design different from the arrangement of voids in the pre-existing tread design. In these cases, grooves will be cut, independent of the pre-existing voids, to accommodate the mold blades of the retread mold design. It is also understood that the longitudinal grooves may be the same between the new and pre-existing tread layers while the lateral grooves may be different, and vice versa.

The step of assembling a retreaded tire further includes applying a bonding layer along an outer side of the pre-existing tread layer and within the one or more voids arranged within the pre-existing tread layer. The bonding layer generally comprises any elastomeric or polymeric material that is curable, that is, a material that may be vulcanized with the application of heat. In particular embodiments, the bonding material is uncured tread material. The bonding layer may be used to provide an outer side or face adapted to receive a new tread layer. For example, the bonding layer may substantially fill any recessed voids, including the grooves cut to accommodate the mold grooves, along with excessively worn locations, or other abnormalities arranged along the outer side of the pre-existing tread layer to achieve a desired face or surface upon which the new tread layer may be applied. The bonding layer facilitates bonding of the new tread layer to the pre-existing tread layer and/or tire carcass.

The bonding layer may be formed by any known means, such as by applying a sheet or strip of bonding layer material atop the outer side of the pre-existing tread layer and/or a portion of the tire carcass, such as when a portion of the pre-existing tread has been removed to the tire carcass. The sheet or strip may have a constant thickness or a variable thickness. Strips may be narrower in width than the sheets, as the strips may be applied at particular locations as necessary spaced across the width of the pre-existing tread layer and/or tire carcass. Further, the bonding layer may be formed of multiple sheets or strips of bonding layer material stacked atop the pre-existing tread layer. In other embodiments, the bonding layer is extruded onto the outer side of the pre-existing tread layer and/or the tire carcass. The extruded bonding layer is initially uncured. A full width of the bonding layer may be extruded onto the pre-existing tread layer and/or tire carcass, which may fill any recesses in the pre-existing tread layer and/or tire carcass, such as recessed voids or uneven wear recesses. Alternatively, the bonding layer may be extruded onto each rib individually, such that any longitudinal grooves remain substantially free of any bonding layer material. This also facilitates formation of a variable thickness bonding layer as the bonding layer is formed along different portions of the pre-existing tread layer and/or tire carcass, such as along individual ribs having different thicknesses within the bonding layer.

A further step in assembling a retreaded tire includes applying a new tread layer along an outer side of the bonding layer such that the bonding layer is arranged between the new tread layer and the pre-existing tread layer, the new tread layer being uncured and having a thickness extending between a top side forming a ground-engaging side of the tread band and a bottom side arranged atop the bonding layer. The new tread layer is formed of any uncured elastomeric or polymeric material that is curable, that is, a material that may be vulcanized with the application of heat. The new tread layer may be applied as, or formed of, a single sheet, a plurality of single strips spaced apart across a width of the tread to each form a tread rib, or a plurality of stacked strips spaced apart across a width of the mold whereby each stacked arrangement of strips forms a tread rib, or by extruding tread material across a partial or full width of the tread. The thickness of the new tread layer may vary, depending on the thickness of tread material retained in the pre-existing tread. As discussed above, the new tread layer may be formed by stacking one or more strips of tread material at any desired location. The strips may each have the same, pre-determined thickness, or strips of different thicknesses may be provided. Accordingly, in particular embodiments, the new tread layer is formed of a plurality of strips of tread material, the plurality of strips arranged in a stacked arrangement. Further, further embodiments of the new tread layer is formed of a plurality of strips arranged in a stacked arrangement at different lateral locations relative the tire carcass, each of the different lateral locations being separated by a longitudinal groove extending longitudinally in a lengthwise direction of the pre-existing tread layer.

Particular embodiments of such methods may further include the step of arranging an annular mold about the outer side of the tread of the assembled retreaded tire, the mold including one or more void molding elements each comprising a protruding member extending radially inward from a mold cavity surface configured to engage the outer side of the tread, each of the one or more void molding elements being arranged to terminate adjacent to one of the or more voids arranged within the pre-existing tread layer outer side_in the grooves that were cut to accommodate them. In performing this step according to particular embodiments, the one or more void molding elements terminating adjacent a void arranged within the pre-existing tread layer may terminate within a depth of the void arranged within the pre-existing tread layer. In such instances, the void molding element may engage the bonding layer within the void arranged within the pre-existing tread layer, although tread material from the new tread layer may be forced within the void and remain between the void molding element and the bonding layer within the void as the void molding element is forced through the new tread layer during molding operations, such as when tread material is arranged above the void. In particular embodiments, the bottom of the void molding element in the retreaded tire is arranged generally the same distance from the belt reinforcement layer as was the original void bottom in the original pre-existing tread layer, that is, the tread under groove height of the original tread and the retread will be similar.

Each void molding element generally has a width, such as at a terminal end of the void molding element, the width being less than a width of the void arranged within the pre-existing tread layer to which the terminal end of the void molding element is arranged. In particular embodiments, the terminal end of the void molding element has a recess for receiving bonding layer and/or new tread layer material as the mold closes and during the molding process. The terminal end of the void molding element may further include extensions or projections extending there from. In particular embodiments, the extensions comprise a pair of opposing projections arranged at opposite transverse extents of the width of the void molding element or of the recess. The extensions may include recesses arranged along their length to allow material to flow into the central recess arranged along the terminal end for receiving excess material. The collected excess material may then be removed after molding and curing operations to expose a larger or deeper void. For example, the collected material may be removed to sufficiently expose the void arranged within the pre-existing tread layer.

Particular embodiments may further include molding the new tread layer and concurrently bonding the new tread layer to the tire carcass by performing a hot retreading molding and curing operation, the curing operation comprising heating the mold and applying sufficient pressure to the tread and tire carcass according to known hot retreading curing operations.

Particular embodiments of the methods discussed above will now be described in further detail below in association with the figures filed herewith exemplifying the performance of particular embodiments of such methods.

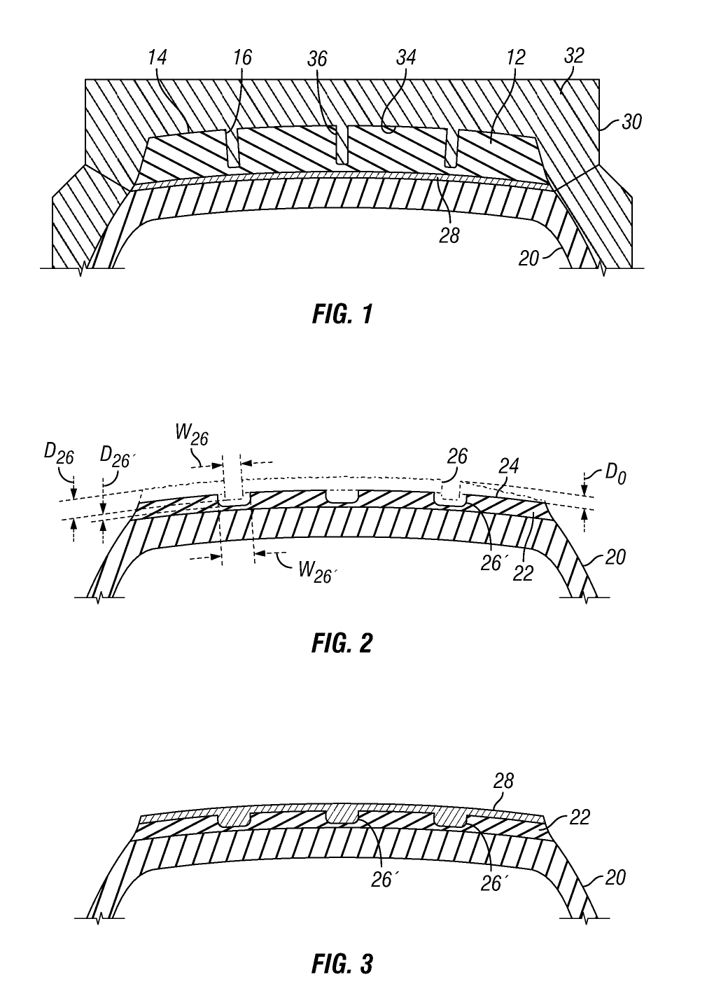

With reference to FIG. 1, prior art methods of hot recapping include arranging a mold 30 about an assembled retreaded tire 10, the assembled retreaded tire comprising a new tread layer 12 arranged overtop a pre-existing tread layer 22 of a tire carcass 20, the pre-existing tread layer buffed to a minimum thickness such that an outer side 24 of the layer is free of any grooves (i.e., any grooves or other voids arranged in the pre-existing or worn tread are removed). In such instances, the pre-existing tread layer thickness is typically between 1 and 3 millimeters (mm) in this prepared condition. A bonding layer 28 formed of bonding material is arranged between the new tread layer and the pre-existing tread layer. The mold 30 includes an outer mold portion 32 arranged annularly radially outward an outer side 14 of new tread layer 12 and having an interior side 34 to engage the top side 14 of the new tread layer. Void molding elements 36 extend inwardly from the inner surface 34 of the outer mold portion 32 for the purpose of forming voids 16 within the new tread layer.

With reference to FIG. 2, in accordance with an embodiment of the invention, a worn tire carcass 20 is shown, where the tread thickness has been worn by a depth Dₒ from a new condition with voids 26 maintained in the pre-existing tread. In particular, in preparation for hot retreading, voids 26 having an original width W₂₆ and depth D₂₆ are widened and deepened to form an enlarged void 26′ having a width W_{26′} and a depth D_{26′} to properly accommodate an adjacently arranged void molding element 36, which may extend into the enlarged void 26′. Enlarging the voids allows a mold of pre-existing design to be employed without reducing the depthwise extension of the void molding element by allowing any void molding element (used to form voids such as grooves or sipes) to extend depthwise and terminate at a location within the final retreaded tire tread that is consistent with the bottom of the void originally arranged in the pre-existing tire tread. In other words, by enlarging the void allows the mold to form a void similar to the void arranged in the pre-existing tread without contacting the cured pre-existing tread layer during the molding operation. It is understood that the void 26 may be widened and/or deepened or otherwise enlarged to consume any desired new tread layer and/or bonding layer material and to allow such material to flow under and around the void molding elements (i.e., the void forming elements of the mold) to establish a cured void profile. When the void is enlarged, the void shape may be reshaped during the enlarging process. Voids 26 shown in the figure are longitudinal grooves forming exposed voids arranged along pre-existing tread layer outer side 24. The longitudinal grooves extend lengthwise in a longitudinal direction of the pre-existing tread layer and in a circumferential direction of the tire. It is also understood that such voids 26 may comprise any exposed void arranged along the pre-existing tread layer, which includes any lateral or longitudinal groove or sipe.

In addition to maintaining one or more pre-existing voids within the pre-existing tread layer, it is understood that one or more new voids may be formed into the pre-existing tread layer prior to applying any bonding layer or new tread to the tire. With reference again to FIG. 2, a new void 26″ is formed into the pre-existing tread layer 22 and any desired location. The location of these new voids may be independent of the location of the pre-existing grooves. New void 26″ may comprise any void contemplated for void 26 and may be sized and shaped as desired, which include having the size and shape of any enlarged void 26′. In the embodiment shown, for example, new void 26″ is a longitudinal groove. New void 26″ may be formed according to any material removal process, including any discussed in association with the enlarging of any void 26.

With reference to FIG. 3, a bonding layer 28 is applied to tire carcass 20 of FIG. 2, and in particular to the pre-existing tread layer 22. Specifically, the bonding layer 28 is locally arranged within the enlarged voids 26′ in the pre-existing layer, whereby a thickness of the bonding layer forms a void having an effective depth D_{26′} and one or more thicknesses of the bonding layer forms a void having an effective width W_{26′}. The bonding layer may have a variable thickness, such that a particular thickness is applied to the pre-existing tread layer outer side 24 and a different thickness applied within voids 26′. Further different thicknesses may be applied to the outer side 24 as needed to account for different worn thicknesses of the pre-existing tread layer. Variable thicknesses may be applied within each void 26 as well. Essentially, the bonding layer fills all voids arranged along the outer side of the pre-existing tread layer, including all pre-existing voids as well as any new voids added to the pre-existing tread layer. Bonding layer also fills any uneven or excessively worn areas along the outer side of the pre-existing tread layer to provide a bonding layer having an outer side that is flat or smoothly contoured. The bonding layer 28 may be applied according to any known or desired method, but in particular embodiments is extruded along the outer side of the pre-existing tread.

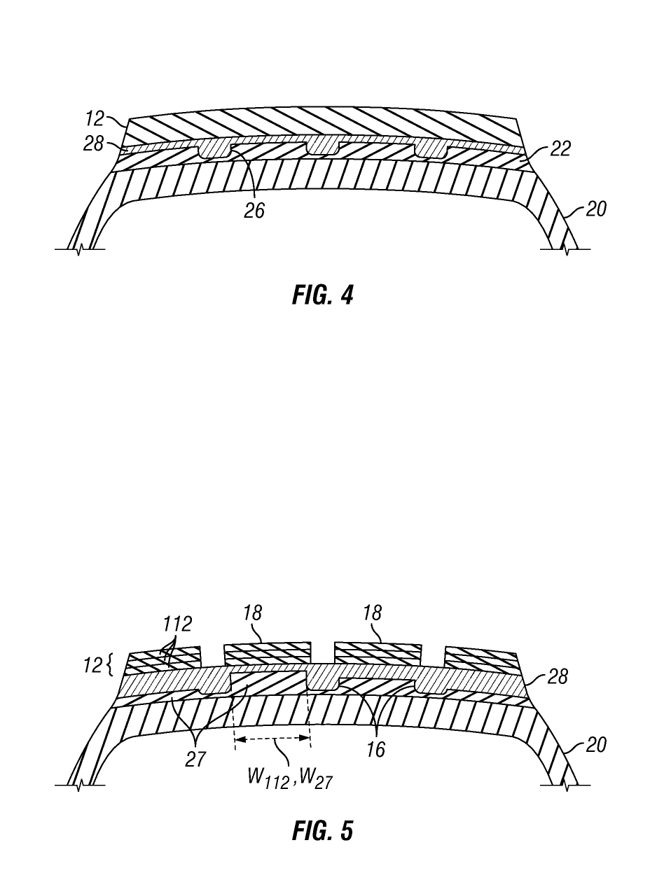

Once a bonding layer is applied to the pre-existing tread layer, the new tread layer is applied to the assembly atop the bonding layer. With reference to FIG. 4, the new tread layer 12 is an uncured sheet of desired thickness. The uncured sheet will be molded to include any desired voids along its outer side to from a desired tread pattern by void molding elements during a molding operation. In particular embodiments, the uncured sheet is free of any voids, as such are formed during the molding operation subsequent its application to the tire carcass. The sheet 12 may be of uniform thickness or of variable thickness. The sheet may also have a length extending a full circumference about the tire, or may be applied in sections fully extend about the tire circumference. In other embodiments, with reference to FIG. 5, the new tread layer 12 may comprise a plurality of strips 112 that may be applied individually about a circumference of the tire or continuously, such as by winding a continuous strip multiple revolutions about the tire circumference. One or more strips may be stacked as desired at different locations to achieve a desired stacked height that forms a thickness of the new tread layer. For example, the strips 112 are shown to be stacked atop ribs 18 of the pre-existing tread layer to form corresponding ribs within the new tread layer. The stacks may form different overall thicknesses, such as to account for a location of increased wear which may require more new replacement tread material than other locations along the tread. As an alternative to stacking strips to form ribs in the new tread layer, a single strip having a thickness similar to the total thickness of the arrangement of stacked strips may be used.

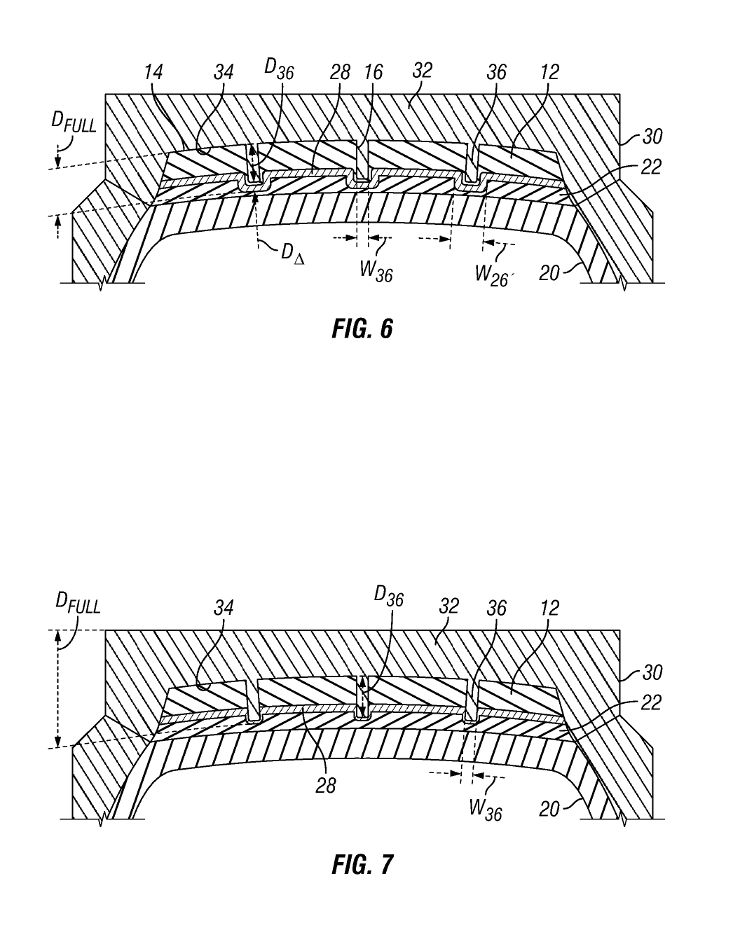

With reference to FIG. 6, a new tread layer 12 is applied atop the bonding layer 28 and the tire carcass 20 to form an assembled retreaded tire. The assembled retreaded tire is arranged within a mold 30. In the embodiment shown, a portion of the new tread layer extends into the void to further reduce the effective width W_{26′} and effective depth D_{26′} to further increase the volume of material arranged within the enlarged void 26′. This may occur when tread material is arranged above the void in the new tread layer, and, as the mold closes, a portion of the tread material from the new tread layer remains beneath the void molding element (that is, the void-forming element forming voids within the retreaded tire tread) as it is forced through the new tread layer during molding operations. It is understood that any material may be arranged within any enlarged void 26′ prior to performing the hot retreading or molding operation. For example, bonding layer material and new tread material are arranged in the enlarged void 26′ in FIG. 6, while it is understood that the bonding layer and/or the new tread layer may be arranged such that only one of such layers extends into the enlarged void 26′.

With continued reference to the embodiment of FIG. 6, void 26′ is enlarged such that, for a given void molding element extending a depth D₃₆ from inner surface 34, the material arranged within the void is able to flow as necessary to provide a final molded thickness approximately equal to the distance D_{Δ} extending between the terminal end of the void molding element 36 and the bottom of the enlarged void 26′. In other words, void 26 is enlarged to provide a void 26′ having a bottom arranged a desired skid depth D_{FULL} from a top side 14 of the new tread layer 12. The desired skid depth D_{FULL} provides the desired distance D_{Δ} between the terminal end of each corresponding void molding element 36 and the bottom of each enlarged void 26′ as discussed above. The enlarged void 26′ is formed to accommodate a pre-existing mold 30 including void molding elements 36 characterized as having of a particular depth D₃₆ and a width W₃₆ while preventing any significant buildup of material within void 26′ and below said void molding element.

In alternative embodiments to those discussed in association with FIGS. 2, 3 and 6, the pre-existing void molding element depth and/or width is reduced to accommodate a void arranged within the pre-existing tread layer. In these alternative embodiments, with reference to FIG. 7, void 26 may not be enlarged and instead the void molding element 36 is shortened to depth D_{36′} to accommodate any bonding layer material and/or new tread layer material arranged within the void or to avoid contacting the cured, pre-existing tread layer. If it is desired for no material to remain within void 26 of the final retreaded tire, the bonding layer and new tread layer may be applied atop the pre-existing layer outer side 24 without arrangement within any voids 26, where the void molding element depth D₃₆ is shortened to approximately equal the skid depth D_{FULL} of the tread. This is generally shown in FIG. 7 by example. It is also understood that material may be molded into the void and removed subsequently by an abrading or cutting operation.

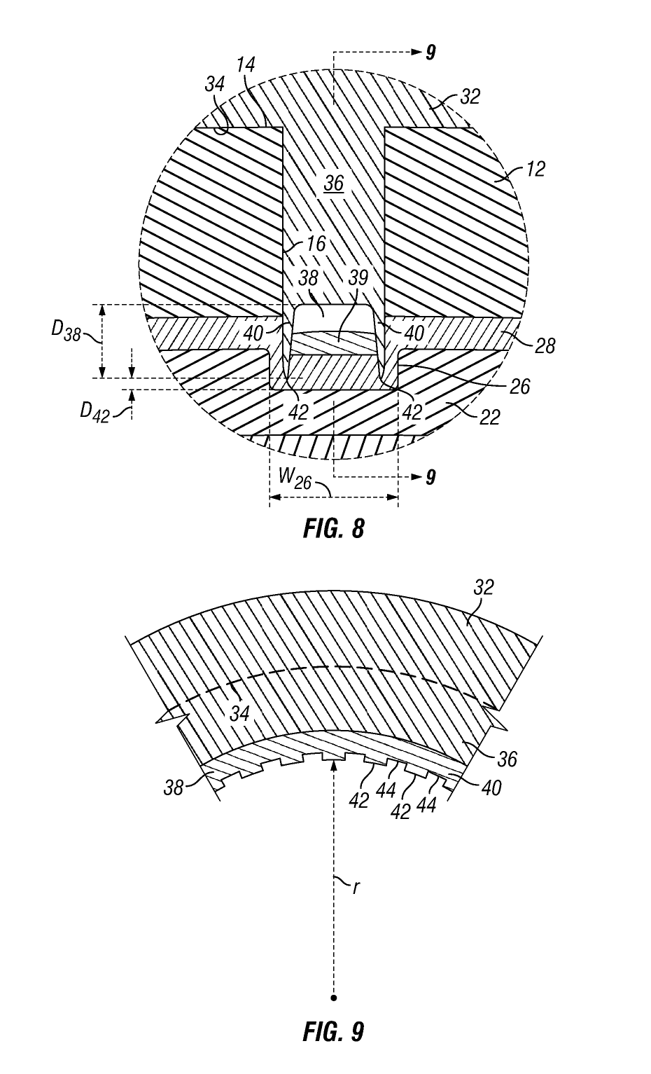

Still, in other embodiments, if any material is arranged within the void, a void molding element having a recess arranged at a terminal end may be employed that is configured to facilitate removal of the excess material subsequent any molding operation. In such embodiments, the recess is arranged between opposing extensions protruding from the terminal end. With reference to FIG. 8, an alternative embodiment to the void molding elements of FIG. 7 comprises a recess 38 arranged at a terminal end of the void molding element 36, whereby the recess is arranged between opposing extensions 40 protruding from the terminal end. In the embodiment shown, the extensions 40 are spaced apart such that the extensions are arranged at the widthwise extent of the void molding element terminal end, although other spacings may be employed. For example, extensions 40 may be spaced apart by a distance generally equal to the width W₂₆ of void 26, which may or may not have been widened or enlarged from its original to a width W_{26′}. In operation, bonding layer material and/or new tread material (generally identified as material 39 in the figure) is collected within recess 38 while extensions 40 form partitions between the collected material 39 and the surrounding bonding layer and/or new tread layer by extensions 40. By separating the collected material 39 from the surrounding material, collected material may be more easily removed by any manual or automatic means for removing the material. For example, manual removal may comprise using pliers or some other gripping device to pull the collected material from the void. To facilitate removal, although it may be unnecessary, a release agent or release material may be arranged along the surfaces of the void 26 before applying the bonding layer and the new tread layer for the purpose of resisting or limiting bonding of the bonding or tread layers to the void. Further, the closer the terminal end 42 of each extension 40 is arranged to the bottom of void 26 (represented by distance D₄₂ in FIG. 6), the removability of the collected material 39 may increase. For example, the terminal end of an extension 40 may be arranged 0 to 0.5 mm from the void bottom.

In particular embodiments, extensions 40 extend a constant distance D₃₈ from void molding element 36 or otherwise provide a constant depth void molding element 36. However, in an effort to facilitate collection of material 39 within recess 38, each extension 40 may vary in depth as each void molding element 36 extends lengthwise along an arc having a radius r extending from the rotational axis A of the tire, which is generally shown in FIG. 9 by example. The terminal end 42 of each extension may follow any non-linear path to provide material access recesses 44 along the length of the void molding element through which bonding and/or new tread layer material may flow during molding operations. The non-linear path may comprise a curvilinear path or a path formed of various rectilinear paths, which includes a stepped path shown in FIG. 9.

By maintaining as much of the pre-existing bonding layer as desired, waste is reduced by eliminating at least a portion of the scrap material produced when the pre-existing tread layer is removed by any abrading operation and less new tread material is required to accomplish tire retreading operations. Further, by maintaining the original voids within the pre-existing tread layer, more surface area is provided to achieve a better bond between adjacent material layers.

While this invention has been described with reference to particular embodiments thereof, it shall be understood that such description is by way of illustration and not by way of limitation. Accordingly, the scope and content of the invention are to be defined by the terms of the appended claims.

What is claimed is:

1. A method for retreading a tire comprising the steps of:
assembling a retreaded tire by:
providing a tire carcass for retreading, the tire carcass having a pre-existing tread layer extending widthwise across the tire in a lateral direction, the pre-existing tread layer including one or more voids extending into a thickness of the pre-existing tread layer from an outer side of the pre-existing tread layer;
applying a bonding layer along an outer side of the pre-existing tread layer and within the one or more voids arranged within the pre-existing tread layer;
applying a new tread layer along an outer side of the bonding layer such that the bonding layer is arranged between the new tread layer and the pre-existing tread layer, the new tread layer being uncured and having a thickness extending between a top side forming an outer, ground-engaging side of the tread layer and a bottom side arranged atop the bonding layer;
arranging an annular mold about the outer side of the tread of the assembled retreaded tire, the mold including one or more void molding elements each comprising a protruding member extending radially inward from a mold cavity surface configured to engage the outer side of the tread, each of the one or more void molding elements being arranged to terminate overtop and adjacent one of the one or more voids arranged within the pre-existing tread layer outer side; and,
molding the new tread layer and concurrently bonding the new tread layer to the tire carcass according to hot retreading operations whereby heat and pressure are applied to the assembled retreaded tire.

2. The method of claim 1, where applying the tread to the bonding layer includes placing a portion of the tread within each of the one or more voids arranged within the pre-existing tread layer.

3. The method of claim 1, wherein the step of providing a tire carcass includes forming at least one of the one or more voids arranged along the pre-existing tread layer outer surface prior to the step of applying the bonding layer to the pre-existing tread layer when the quantity of the one or more voids then existing in the pre-existing tread layer is less than the quantity of the one or more void molding elements extending from the mold and arranged to terminate adjacent one of the or more voids arranged within the pre-existing tread layer outer side in the step of arranging the annular mold about the outer side of the tread, each of the one or more voids being formed at a location configured to facilitate the arrangement achieved in the step of arranging the annular mold about the outer side of the tread.

4. The method of claim 1, where the one or more void molding elements terminating adjacent the void arranged in the pre-existing tread layer terminate within the void.

5. The method of claim 4, where the one or more void molding elements terminate a distance from the bottom of the recessed void comprising a groove.

6. The method of claim 1 further comprising the step of:
enlarging the void arranged within the pre-existing tread of the tire carcass prior to performing the step of applying the bonding layer.

7. The method of claim 1 further comprising the step of:
widening the void arranged within the pre-existing tread of the tire carcass.

8. The method of claim 1 further comprising the step of:
deepening the void arranged within the pre-existing tread of the tire carcass.

9. The method of claim 1, where the void arranged within the pre-existing tread layer is a groove.

10. The method of claim 1, where the void molding element has width, the width being less than a width of the void arranged within the pre-existing tread layer to which the terminal end of the void molding element is arranged.

11. The method of claim 1, wherein the void molding element engages the bonding layer within the void arranged within the pre-existing tread layer.

12. The method of claim 1, wherein the terminal end of the void molding element has a recess.

13. The method of claim 1, wherein the terminal end of the void molding element has extensions projecting there from.

14. The method of claim 13, wherein the projections comprise a pair of opposing extensions arranged at opposite extends of the width of the void molding element.

15. The method of claim 13, wherein the extensions each have a terminal end that extends lengthwise along an alternating path in an arcuate direction.
